(19) United States
(12) Patent Application Publication
(10) Pub. No.: US 2026/0118148 A1
(43) Pub. Date: Apr. 30, 2026

(54) METHOD FOR OPERATING AN ULTRASONIC FLOWMETER AND ULTRASONIC FLOWMETER

(71) Applicant: KROHNE Messtechnik GmbH, Duisburg (DE)

(72) Inventors: Johannes KUNZE, Muelheim (DE); Christian DEMSKI, Buxtehude (DE)

(73) Assignee: KROHNE Messtechnik GmbH, Duisburg (DE)

(21) Appl. No.: 19/371,425

(22) Filed: Oct. 28, 2025

(30) Foreign Application Priority Data
Oct. 28, 2024 (DE) 10 2024 131 387.0

(51) Int. Cl. G01F 1/667; G01F 1/66

(52) U.S. Cl. CPC G01F 1/667; G01F 1/662

(57) ABSTRACT

A method for operating an ultrasonic flowmeter is provided. The ultrasonic flowmeter has at least a first ultrasonic transducer pair and a second ultrasonic transducer pair. The first ultrasonic transducer pair is arranged on a measuring tube such that a first measuring path with a length L1 is spanned between the ultrasonic transducers of the first ultrasonic transducer pair. The second ultrasonic transducer pair is arranged on the measuring tube in such a way that a second measuring path with a length L2 is spanned between the ultrasonic transducers of the second ultrasonic transducer pair. The ultrasonic flowmeter has a control and evaluation unit for controlling the ultrasonic transducers and for evaluating the measuring signals captured by the ultrasonic transducers.

This nonprovisional application claims priority under 35 U.S.C. § 119(a) to German Patent Application No. 102024131 387.0, which was filed in Germany on October 28, 2024, and which is herein incorporated by reference.

### BACKGROUND OF THE INVENTION

### Field of the Invention

The present invention relates to a method for operating an ultrasonic flowmeter, wherein the ultrasonic flowmeter has at least a first ultrasonic transducer pair and a second ultrasonic transducer pair, wherein the first ultrasonic transducer pair is arranged on a measuring tube in such a way that a first measuring path with a length L1 is spanned between the ultrasonic transducers of the first ultrasonic transducer pair, and wherein the second ultrasonic transducer pair is arranged on the measuring tube in such a way that a second measuring path with a length L2 is spanned between the ultrasonic transducers of the second ultrasonic transducer pair, and wherein the ultrasonic flowmeter has a control and evaluation unit for controlling the ultrasonic transducer and for evaluating the measuring signals captured by the ultrasonic transducer.

Furthermore, the invention relates to a corresponding ultrasonic flowmeter comprising at least a first pair of ultrasonic transducers and a second pair of ultrasonic transducers, wherein the first pair of ultrasonic transducers is arranged on a measuring tube in such a way that a first measuring path of length L1 is spanned between the ultrasonic transducers of the first pair of ultrasonic transducers, and wherein the second ultrasonic transducer pair is arranged on the measuring tube in such a way that a second measuring path of length L2 is spanned between the ultrasonic transducers of the second ultrasonic transducer pair, and wherein the ultrasonic flowmeter has a control and evaluation unit for controlling the ultrasonic transducers and for evaluating the measuring signals captured by the ultrasonic transducers.

### Description of the Background Art

It is known from the prior art that, in order to monitor or check the correct functioning of an ultrasonic flowmeter or the correct functioning of the ultrasonic transducer, the transit times of measuring signals on different measurement paths are compared with each other.

For example, prior art DE 102018118489 A1 discloses a method for operating an ultrasonic measuring device for capturing the flow velocity of a flowing medium, in which at least one additional parameter is captured during a measurement and in which a plausibility check is performed for a respective transit time determined from the ultrasonic signal on the basis of this additional parameter. Such an additional parameter is obtained, for example, from a secondary signal arriving before and/or after the actual ultrasonic signal. Alternatively, an additional parameter may be the intensity or the pulse shape of the receive signal.

Publication EP 2592395 A1 relates to a method for operating an ultrasonic flowmeter having several measuring paths, wherein the accuracy of the flow measurement is improved by comparing the different measuring paths with each other.

Publication WO2013006090 A1 describes a calibration method for an ultrasonic flowmeter, wherein the ultrasonic velocity is determined in a non-flowing medium and compared with a reference value for the medium.

### SUMMARY OF THE INVENTION

Based on the state of the art described above, the object of the invention is to provide a method for operating an ultrasonic flowmeter that implements particularly reliable verification of the functionality of the individual ultrasonic transducers.

In addition, the object of the invention is to provide an ultrasonic flowmeter that is particularly reliable.

According to a first teaching of the present invention, the aforementioned object is achieved by a method described at the outset, in that the method comprises the following steps: emitting and receiving at least one first measuring signal along the first measurement path in and/or against the direction of flow of a medium flowing through the measuring tube by the first pair of ultrasonic transducers, determining whether the flow velocity of the medium is below a specified velocity limit value, determining a value of a comparison parameter from the first measuring signal and determining an expected value for the comparison parameter on the second measuring path based on the value of the comparison parameter determined on the first measuring path, if the flow velocity is below the specified velocity limit value: emitting and receiving at least one second measuring signal along the second measurement path in and/or against the direction of flow of a medium flowing through the measuring tube by the second pair of ultrasonic transducers, determining the second comparison parameter from the second measuring signal, plausibility check by comparing the second comparison parameter with its expected value.

According to the invention, it was recognized that a plausibility check of the functioning of the ultrasonic transducers can be performed particularly advantageously when there is no or almost no flow of the medium through the measuring tube. Such a situation has the advantage that there is no flow profile in the measuring tube that has different velocity components along the flow cross section.

This means that measurement results recorded on measurement paths that pass through different areas of the flow cross section can be compared directly with each other. In detail, it is even possible to determine the value of a comparison parameter on a second measurement path based on a measured value of this comparison parameter on a first measurement path. In particular, the length of the measurement paths L1 and L2 must be taken into account.

In the state according to the invention, the medium has the same flow velocity across the entire flow cross section, which means that no unknowns are included in determining the expected value of the comparison parameter for the second measuring path. In the state according to the invention, the flow velocity is either very slow. Alternatively, the state in which the medium is at rest, i.e., there is no flow velocity, can also be determined.

Due to the same process conditions existing on the different measurement paths, the values of the comparison parameters can be directly compared with each other and also converted into each other.

This makes it possible not only to compare measured values with theoretical reference values. Rather, measured values recorded on different measurement paths can be compared with each other, which is particularly advantageous for performing a check of the correct functionality of the ultrasonic transducer.

The first measuring signal can be a simple measuring signal emitted by an ultrasonic transducer in the direction of flow to a second ultrasonic transducer.

Alternatively, the first measuring signal can be a simple measuring signal emitted by an ultrasonic transducer against the direction of flow to a second ultrasonic transducer.

Alternatively, the first measuring signal may be formed of a first partial measuring signal transmitted by a first ultrasonic transducer in the direction of flow to a second transducer and a second partial measuring signal transmitted by the second ultrasonic transducer against the direction of flow to the first ultrasonic transducer.

Depending on the design of the first measuring signal, it can be determined in different ways whether the flow velocity of the medium is below the limit velocity. Various possibilities are described below.

According to an advantageous design of the method, the first measuring signal comprises a first partial measuring signal that travels through the first measurement path in the direction of flow and a second partial measuring signal that travels through the first measurement path against the direction of flow. To determine whether the flow velocity is below the velocity limit value, the transit time difference between the first partial measurement signal and the second partial measurement signal is determined. Furthermore, a check is made to determine whether the transit time difference is below a difference limit value. If the transit time difference is below the difference limit value, the flow velocity is below the velocity limit value. This means that it is sufficiently small for the plausibility check according to the invention to be performed.

According to one design, the velocity limit value characterizes the velocity at which the flow profile transitions into a flow profile that has a velocity distribution across the flow cross section. Below the velocity limit value, the medium has a uniform flow, i.e., it has no velocity distribution across the flow cross section.

According to a further design, the velocity limit is so small that even if the medium flows at a velocity slightly above the velocity limit, it still exhibits a uniform flow profile without velocity distribution.

According to a further design, the velocity limit is set such that the flow velocity is close to zero or equal to zero.

According to a further advantageous design of the method, the first measuring signal is a simple measuring signal that passes through the first measurement path in or against the direction of flow. To determine whether the flow velocity is below the velocity limit value, the absolute transit time of the first measuring signal between the ultrasonic transducers of the first ultrasonic transducer pair is compared with a transit time limit value. The flow velocity is below the velocity limit value if the absolute transit time of the first measuring signal exceeds a lower transit time limit value or falls below an upper transit time limit value.

If the first measuring signal is a signal that is transmitted to a second ultrasonic transducer in the opposite direction to the flow direction, the absolute transit time of the first measuring signal is compared with an upper transit time limit. If the transit time of the first measuring signal is below this transit time limit, the flow velocity is below the velocity limit and is therefore sufficiently low for the plausibility check according to the invention to be performed.

If the first measuring signal is a signal that is transmitted in the direction of flow to a second ultrasonic transducer, the absolute transit time of the first measuring signal is compared with a lower transit time limit value. If the transit time of the first measuring signal is above this transit time limit value, the flow velocity is below the velocity limit value and is therefore sufficiently low for the plausibility check according to the invention to be performed.

If the absolute transit time of a measurement signal transmitted from a first ultrasonic transducer to a second ultrasonic transducer is used to determine whether there is no or almost no flow velocity, then at least one further operating parameter, in particular the temperature of the medium and/or the pressure of the medium, is preferably determined during operation of the ultrasonic flowmeter. The lower transit time limit or the upper transit time limit is then dependent on the at least one further parameter.

For this purpose, the ultrasonic flowmeter according to a further advantageous design additionally has a further sensor, in particular a temperature sensor and/or a pressure sensor, wherein the temperature sensor measures the temperature of the medium and/or wherein the pressure sensor measures the pressure in the medium. According to this design, the lower transit time limit value or the upper transit time limit value is determined depending on the current temperature and/or the current pressure of the medium.

It is also preferable if the medium in the measuring tube is known. If the medium is known, the lower transit time limit value or the upper transit time limit value is determined depending on the medium.

If, in accordance with one of the designs described above, it is determined that the flow velocity is below the velocity limit value, a plausibility check of the measured values captured with the second ultrasonic transducer pair and the measured values captured with the first ultrasonic transducer pair is performed in a next method step.

For this purpose, a value of a comparison parameter is determined from the first measuring signal. Based on this value of the comparison parameter, an expected value for the comparison parameter is determined on the second measurement path.

This expected value does not have to be determined each time the method is performed. If, for example, the speed limit value is so low that the plausibility check is only performed in a situation where there is no flow, the value of the comparison parameter for the second measurement path can also be stored in the control and evaluation unit. In this case, the expected value corresponds to this stored value.

According to one design, the comparison parameter for the plausibility check is the absolute transit time of a measuring signal between two ultrasonic transducers of an ultrasonic transducer pair.

According to a further design, the comparison parameter is the transit time difference between a partial measurement signal traveling in the direction of flow and a partial measurement signal traveling in the opposite direction of flow.

If the length L1 of the first measuring path is greater or less than the length L2 of the second measuring path by a known value, the difference in length is taken into account when determining the expected value of the comparison parameter for the second measuring path.

If the length L1 of the first measuring path corresponds to the length L2 of the second measuring path, the expected value of the comparison parameter for the second measuring path essentially corresponds to the value of the comparison parameter for the first measuring path when there is no or almost no flow velocity.

According to a further design of the method, at least one further comparison parameter is the frequency spectrum of the measuring signal received by an ultrasonic transducer and/or the signal-to-noise ratio of the measuring signal received by an ultrasonic transducer. These comparison parameters are not or not significantly dependent on the length of the measurement paths. The expected value for the second measurement path of these comparison parameters thus corresponds to the value measured on the first measurement path, in particular taking into account usual tolerances.

According to a further design of the method, more than two measurement paths are provided.

According to this design, an expected value for the second measurement path and for the third measurement path can be determined based on the value of the comparison parameter measured on the first measurement path.

For plausibility checking, the value of the comparison parameter determined on the second measurement path can be compared with its expected value. In addition, the value of the comparison parameter determined on the third measurement path can be compared with its expected value.

Overall, the described designs of the method ensure a particularly reliable verification of the correct functioning of the individual ultrasonic transducers.

According to a second teaching of the present invention, the task mentioned at the beginning is solved by an ultrasonic flowmeter described at the beginning in that the control and evaluation unit performs one of the methods described above during operation.

According to an example, the first ultrasonic transducer pair comprises a first ultrasonic transducer and a second ultrasonic transducer, and the second ultrasonic transducer pair comprises a third ultrasonic transducer and a fourth ultrasonic transducer, wherein preferably all ultrasonic transducers are designed as ultrasonic transmitters and as ultrasonic receivers.

For example, the first ultrasonic transducer and the second ultrasonic transducer of the first ultrasonic transducer pair can be arranged on the measuring tube in a staggered manner in the direction of flow such that the first measuring path penetrates the interior of the measuring tube without reflection. Alternatively, the first ultrasonic transducer and the second ultrasonic transducer can be arranged on the measuring tube in such a way that they are offset in the direction of flow, so that the first measuring path includes a reflection on the inner wall of the measuring tube, i.e., it is V-shaped. It is also conceivable that the first measuring path has more than one reflection on the inner wall of the measuring tube.

The ultrasonic transducers of the second ultrasonic transducer pair can be arranged on the measuring tube in such a way that they are offset in the direction of flow, so that the second measuring path penetrates the interior of the measuring tube without reflection. Alternatively, the third ultrasonic transducer and the fourth ultrasonic transducer can be arranged on the measuring tube in such a way that they are offset in the direction of flow, so that the second measuring path has a reflection on the inner wall of the measuring tube, i.e., it is V-shaped. It is also conceivable that the second measuring path has more than one reflection on the inner wall of the measuring tube.

According to the design described above, the first ultrasonic transducer pair and the second ultrasonic transducer pair have a total of four ultrasonic transducers.

According to a further design, the first ultrasonic transducer pair and the second ultrasonic transducer pair have a total of three ultrasonic transducers. According to this design, the first ultrasonic transducer forms a first ultrasonic transducer pair with the second ultrasonic transducer, and the first ultrasonic transducer further forms a second ultrasonic transducer pair with the third ultrasonic transducer. It is particularly preferred that at least the first ultrasonic transducer according to this design is designed as a phased array transducer.

According to a further design, the length L1 of the first measuring path corresponds to the length L2 of the second measuring path.

In addition, the length L1 of the first measuring path may also be greater or less than the length L2 of the second measuring path by a known value.

According to one design, the first measuring path and the second measuring path are arranged in the same flow section of the flowing medium. According to this design, the different measuring paths measure the same flow section, wherein the different measuring paths pass through different flow cross section sections.

For example, the first pair of ultrasonic transducers is arranged on the measuring tube in such a way that the first measuring path passes through the center of the measuring tube, i.e., in such a way that the first measuring path intersects the measuring tube axis. The second pair of ultrasonic transducers is arranged above or below the first pair of ultrasonic transducers in such a way that it captures the flow cross section in the peripheral region. According to one design, a second pair of ultrasonic transducers is arranged above the first pair of ultrasonic transducers and a third pair of ultrasonic transducers is arranged below the first pair of ultrasonic transducers.

The terms “above” and “below” are defined in relation to the measuring tube axis and in a top view of the measuring tube cross section.

According to a further design, the first measuring path and the second measuring path are arranged offset from each other in the direction of flow. According to this design, the pairs of ultrasonic transducers can capture the same flow cross-sectional area. For example, the first measuring path and the second measuring path measure the flow cross section centrally, i.e., both measuring paths intersect the measuring tube axis.

According to another design, the first measuring path and the second measuring path are arranged offset relative to each other in the direction of flow, wherein the first measuring path and the second measuring path measure different areas of the flow cross section. According to this design, the first measuring path is preferably designed to be shorter or longer than the second measuring path.

According to a further design of the ultrasonic flowmeter, at least three pairs of ultrasonic transducers are provided, which are subjected to a plausibility check according to the invention during operation to ensure correct functioning.

The ultrasonic flowmeter according to the invention implements various measurement paths, wherein the values measured on the measurement paths are compared with each other at least indirectly in order to check the functioning of the ultrasonic transducers implementing the measurement paths, wherein it is ensured that the basic process situation also allows such a comparison.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is an example of a method according to the invention,

FIG. 2 is an example of a method according to the invention,

FIG. 3 is an example of an ultrasonic flowmeter according to the invention,

FIG. 4 is an example of an ultrasonic flowmeter according to the invention,

FIG. 5 is an example of an ultrasonic flowmeter according to the invention, and

FIG. 6 is an example of an ultrasonic flowmeter according to the invention.

### DETAILED DESCRIPTION

FIG. 1 shows an example of a method 1 for operating an ultrasonic flowmeter 2. The ultrasonic flowmeter 2 has a first ultrasonic transducer pair 3 with a first ultrasonic transducer 8 and a second ultrasonic transducer 9, wherein the ultrasonic transducer pair 3 is arranged on a measuring tube 4 in such a way that a first measuring path 5 is spanned between the ultrasonic transducers 8, 9 of the first ultrasonic transducer pair 3. Furthermore, the ultrasonic flowmeter 2 has a second ultrasonic transducer pair 6 with a third ultrasonic transducer 10 and a fourth ultrasonic transducer 11, wherein the second ultrasonic transducer pair 4 is arranged on the measuring tube 4 in such a way that it spans a second measuring path 7.

In a first step 12 of the method 1, a first partial measurement signal is emitted by the first ultrasonic transducer 8 of the first ultrasonic transducer pair 3, which is received by the second ultrasonic transducer 9 after passing through the medium. Furthermore, the second ultrasonic transducer 9 transmits a second partial measurement signal which, after passing through the medium, is received by the first ultrasonic transducer 8.

In a next step 13, it is determined whether the flow velocity of the flowing medium is below a specified velocity limit value.

For this purpose, the transit time difference between the first partial measurement signal, which is transmitted in the direction of flow, and the second partial measurement signal, which is transmitted in the direction opposite the direction of flow, is calculated. If this transit time difference is below a transit time difference limit value, the flow velocity of the medium is below the specified velocity limit value. This means that a process situation exists in which it is advantageous to compare the measured values of the different ultrasonic transducers 8, 9, 10, 11.

In a next step 14, a comparison parameter is determined from the first measuring signal, which is composed of the first partial measuring signal and the second partial measuring signal. In the example, the comparison parameter is the already-determined time difference between the first partial measuring signal and the second partial measuring signal. Based on the measured transit time difference on the first measurement path, an expected value for the transit time difference on the second measurement path is determined.

In a next step 15, a partial measurement signal is transmitted by the third ultrasonic transducer 10 in the direction of flow, which is received by the fourth ultrasonic transducer 11 after passing through the medium. Furthermore, the fourth ultrasonic transducer 11 transmits a second partial measurement signal, which is received by the third ultrasonic transducer 10 after passing through the medium.

The time difference between these partial measurement signals is then determined as a comparison parameter 16.

Finally, a plausibility check 17 is performed. Specifically, a check is performed to determine whether the transit time difference on the second measurement path corresponds to the expected transit time difference. If the measured transit time difference corresponds to the expected value, taking into account a tolerance range, it can be assumed that the ultrasonic transducer 8, 9, 10, 11 are measuring correctly.

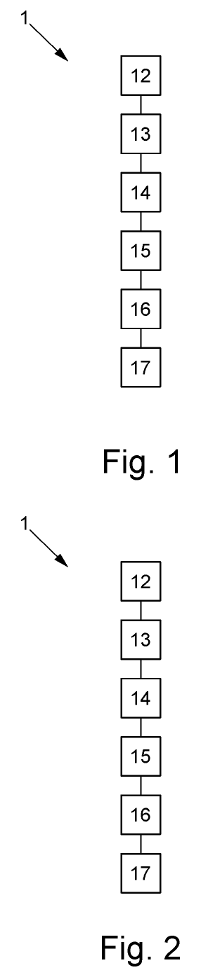

FIG. 2 shows an example of a method 1 for operating an ultrasonic flowmeter 2, wherein the ultrasonic flowmeter 2 has a first ultrasonic transducer pair 3 arranged on a measuring tube 4 in such a way that a first measuring path 5 is spanned between the ultrasonic transducers 8, 9 of the first ultrasonic transducer pair 3, and wherein the ultrasonic flowmeter 2 has a second ultrasonic transducer pair 6 which is arranged on the measuring tube 4 in such a way that it spans a second measuring path 7.

In a first step 12 of the method 1, a first partial measurement signal is emitted by the first ultrasonic transducer 8 of the first ultrasonic transducer pair 3, which is received by the second ultrasonic transducer 9 after passing through the medium. Furthermore, the second ultrasonic transducer 9 transmits a second partial measurement signal, which is received by the first ultrasonic transducer 8 after passing through the medium.

In a next step 13, it is determined whether the flow velocity is below a specified velocity limit value.

For this purpose, the transit time difference is formed between the first partial measurement signal, which is transmitted in the direction of flow, and the second partial measurement signal, which is transmitted in the opposite direction to the direction of flow. If this transit time difference is below a transit time difference limit value, the flow velocity of the medium is below the specified velocity limit value. In the example, the flow velocity in the process situation in which the plausibility check is performed is zero.

In a next step 14, a comparison parameter is determined from the first measuring signal. In the example, the comparison parameter is the absolute transit time of the partial measurement signal emitted in the direction of flow from the first ultrasonic transducer 8 to the second ultrasonic transducer 9. Furthermore, an expected value for the second comparison parameter determined from the second measuring signal is determined from the first comparison parameter.

In a next step 15, a partial measurement signal is transmitted in the direction of flow by the third ultrasonic transducer 10, which is received by the fourth ultrasonic transducer 11 after passing through the medium.

The second comparison parameter, namely the absolute transit time of this partial measuring signal, is determined 16 from the partial measuring signal of the second measuring signal, which is transmitted in the direction of flow of the flowing medium.

Finally, a plausibility check 17 is performed. Specifically, a check is performed to determine whether the second value of the comparison parameter measured on the second measuring signal corresponds to its expected value.

If the absolute transit time of the partial measurement signal of the second measuring signal corresponds to the expected transit time, taking into account a tolerance range, it can be assumed that the ultrasonic transducers 8, 9, 10, 11 are functioning correctly.

In addition to the analysis and comparison of the transit times and/or transit time differences, other parameters of the measuring signals can also be compared with each other. For example, the frequency spectrum of the second received measuring signal can be compared with the frequency spectrum of the first received measuring signal. Since the frequency spectrum is independent of the length of the measurement paths, the expected value of the second frequency spectrum corresponds to the frequency spectrum of the first measuring signal.

In addition, the signal-to-noise ratio of the received second measuring signal can be compared with the signal-to-noise ratio of the received first measuring signal.

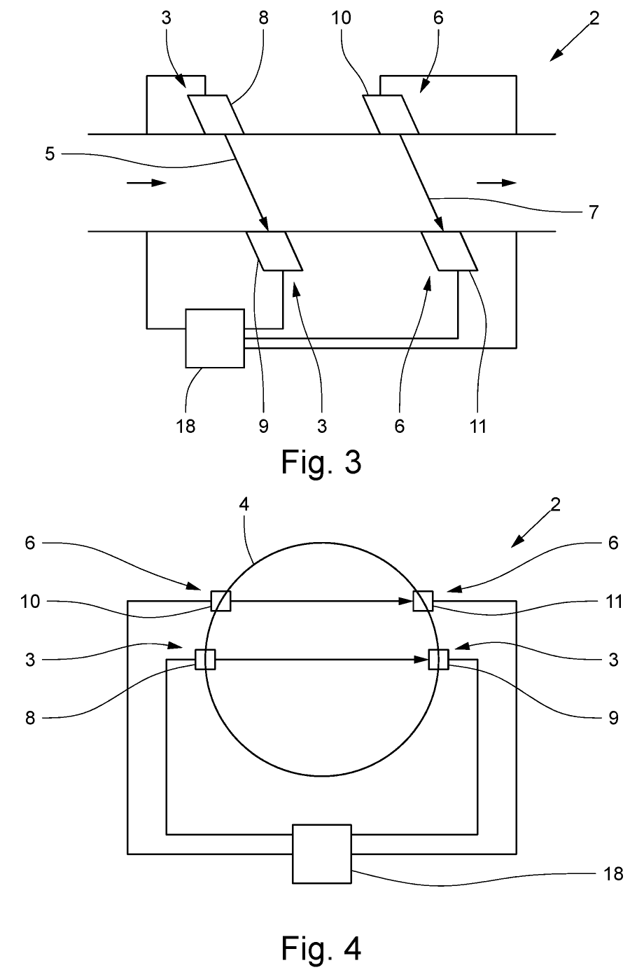

FIG. 3 shows an example of an ultrasonic flowmeter 2 that is designed to perform the method 1 according to the invention.

The ultrasonic flowmeter 2 has a first ultrasonic transducer pair 3 with a first ultrasonic transducer 8 and a second ultrasonic transducer 9, wherein the first ultrasonic transducer 8 and the second ultrasonic transducer 9 are each designed as an ultrasonic transmitter and as an ultrasonic receiver.

The first ultrasonic transducer pair 3 is arranged on a measuring tube 4 in such a way that the first ultrasonic transducer 8 and the second ultrasonic transducer 9 span a first measuring path 5 with a length L1.

Furthermore, the ultrasonic flowmeter 2 has a second ultrasonic transducer pair 6 with a third ultrasonic transducer 10 and a fourth ultrasonic transducer 11, wherein the third ultrasonic transducer 10 and the fourth ultrasonic transducer 11 are each designed as an ultrasonic transmitter and an ultrasonic receiver.

The second pair of ultrasonic transducers 6 is arranged on a measuring tube 4 in such a way that the third ultrasonic transducer 10 and the fourth ultrasonic transducer 11 span a second measuring path 7 with a length L2.

In the example shown, the length L1 essentially corresponds to the length L2. The two measuring signals each intersect the measuring tube axis. Furthermore, the two pairs of ultrasonic transducers 3, 6 are offset from each other in the direction of flow .

Furthermore, the ultrasonic flowmeter 2 is arranged with a control and evaluation unit 18 for controlling the ultrasonic transducers 8, 9, 10, 11 and for evaluating the measuring signals recorded by the ultrasonic transducers 8, 9, 10, 11. During operation, the control and evaluation unit 18 performs a plausibility check 1 according to the invention.

If it is determined during operation that there is no or almost no flow velocity, i.e., the medium in the measuring tube 4 is at rest, the plausibility test according to the invention is performed.

This has the advantage that, when determining the expected value of the comparison parameter for the second measuring path according to the invention, there is no inaccuracy due, for example, to turbulence in the flow profile.

FIG. 4 shows an example of an ultrasonic flowmeter 2 for performing the method 1 according to the invention in a top view of the measuring tube cross section.

This example also comprises two pairs of ultrasonic transducers 3, 6 arranged on a measuring tube 4. In contrast to the example shown in FIG. 3, the ultrasonic transducer pairs 3, 6 are arranged in the same flow section. The first measuring path 5 intersects the measuring tube axis, while the second measuring path 7 is arranged above the first measuring path 5. The second measuring path 7 thus captures the upper region of the flowing medium.

In the event that it is determined or manually specified that there is no or almost no flow velocity, the measured values of the ultrasonic transducers 8, 9, 10, 11 can be compared with each other, at least indirectly, in order to check that the ultrasonic transducers 8, 9, 10, 11 are functioning correctly.

FIG. 5 shows an example of an ultrasonic flowmeter 2 designed to perform the method 1 according to the invention, wherein the ultrasonic flowmeter 2 has three pairs of ultrasonic transducers 3, 6, 19. The three pairs of ultrasonic transducers 3, 6, 19 are arranged one above the other in the same flow section. They therefore measure different areas of the flow profile.

If it is determined on the first measuring path 5 that there is no flow velocity or almost no flow velocity, or if this is specified manually by the user, expected values for the comparison parameter of the second measuring path 7 and the third measuring path 20 can be determined based on the comparison parameter determined on the first measuring path 5.

If the comparison parameter determined on the second measuring path 7 corresponds to its expected value, taking into account a tolerance range, and if the comparison parameter determined on the third measuring path 20 corresponds to its expected value, taking into account a tolerance range, it can be assumed that the ultrasonic transducer is functioning correctly.

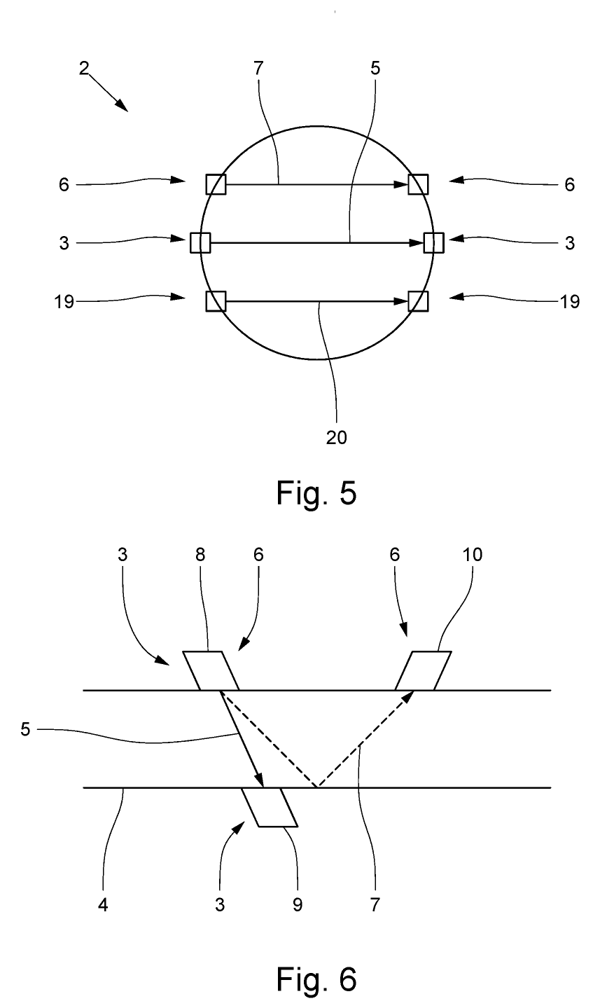

FIG. 6 shows an example of an ultrasonic flowmeter 2 that is designed to perform the method 1 according to the invention. In contrast to the examples described above, there are two pairs of ultrasonic transducers 3, 6, which have a total of three ultrasonic transducers 8, 9, 10. The first pair of ultrasonic transducers 3 is formed by the first ultrasonic transducer 8 and the second ultrasonic transducer 9. The second pair of ultrasonic transducers 6 is formed by the first ultrasonic transducer 8 and the third ultrasonic transducer 10.

The first ultrasonic transducer 8 and the second ultrasonic transducer 9 are arranged opposite each other on the measuring tube 4. The first measuring path 5 intersects the measuring tube axis and strikes the second ultrasonic transducer 9 directly, i.e., without reflection from the inner wall of the measuring tube. The third ultrasonic transducer 10 is arranged on the same side as the first ultrasonic transducer 8 when viewed from above the measuring tube 4. The second measuring path 7 is V-shaped in the top view shown and thus includes a reflection on the inner wall of the measuring tube.

The first ultrasonic transducer 8 is therefore designed in such a way that it transmits to both the first measuring path 5 and the second measuring path 7. For this purpose, the ultrasonic transducer 8 is designed as a phased array transducer. For example, the first ultrasonic transducer 8 transmits a measuring signal to the first measurement path 5 and to the second measurement path 7 at different times.

If it is determined on the first measurement path 5 that there is no flow velocity or almost no flow velocity, or if this condition is manually specified by the user, the functionality of the ultrasonic transducers of the second ultrasonic transducer pair 6 can be checked by comparing a comparison parameter captured on the second measurement path 7 with an expected value based on the comparison parameter determined on the first measurement path 5.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for operating an ultrasonic flowmeter that comprises at least a first ultrasonic transducer pair and a second ultrasonic transducer pair, the first ultrasonic transducer pair is arranged on a measuring tube such that a first measuring path with a first length is spanned between the ultrasonic transducers of the first ultrasonic transducer pair, and the second ultrasonic transducer pair is arranged on the measuring tube such that a second measuring path with a second length is spanned between the ultrasonic transducers of the second ultrasonic transducer pair, the ultrasonic flowmeter also comprising a control and evaluation unit to control the ultrasonic transducers and to evaluate measuring signals captured by the ultrasonic transducers, the method comprising:
emitting and receiving of at least one first measuring signal along a first measurement path in and/or against a direction of flow of a medium flowing through the measuring tube by the first ultrasonic transducer pair;
determining whether the flow velocity of the medium is below a specified velocity limit value;
determining a value of a comparison parameter from the first measuring signal; and
determining an expected value for the comparison parameter on the second measuring path based on the value of the comparison parameter determined on the first measuring path,
wherein, if the flow velocity is below the specified velocity limit value:
emitting and receiving at least one second measuring signal along the second measurement path in and/or against the flow direction of a medium flowing through the measuring tube by the second ultrasonic transducer pair;
determining the second comparison parameter from the second measuring signal; and
performing a plausibility check by comparing the second comparison parameter with its expected value.

2. The method according to claim 1, wherein the first measuring signal comprises a first partial measuring signal that passes through the first measurement path in the direction of flow and a second partial measuring signal that passes through the first measurement path against the direction of flow, and wherein, in order to determine whether the flow velocity is below the velocity limit value, the transit time difference between the first partial measurement signal and the second partial measurement signal is determined and that a check is made as to whether the transit time difference is below a difference limit value.

3. The method according to claim 1, wherein the first measuring signal is a single measuring signal that passes through the first measurement path in or against the direction of flow, and wherein, in order to determine whether the flow velocity is below the velocity limit value, the absolute transit time of the first measuring signal between the ultrasonic transducers of the first ultrasonic transducer pair is compared to a transit time limit value, and wherein the flow velocity is below the velocity limit value if the absolute transit time of the first measuring signal exceeds a lower transit time limit value or falls below an upper transit time limit value.

4. The method according to claim 3, wherein the ultrasonic flowmeter further comprises a temperature sensor and/or a pressure sensor, wherein the temperature sensor measures the temperature of the medium and/or wherein the pressure sensor measures the pressure in the medium, and wherein the upper and lower transit time limits depend on the current temperature and/or the current pressure of the medium.

5. The method according to claim 1, wherein the comparison parameter for the plausibility check is the absolute transit time of a measuring signal between two ultrasonic transducers of an ultrasonic transducer pair.

6. The method according to claim 1, wherein the comparison parameter is the transit time difference between a partial measurement signal traveling in the direction of flow and a partial measurement signal traveling in the opposite direction to the flow.

7. The method according to claim 1, wherein the first length of the first measuring path is greater or less than the second length of the second measuring path by a known value, and wherein the difference in length is taken into account when determining the expected value of the comparison parameter for the second measuring path.

8. The method according to claim 1, wherein the first length of the first measuring path corresponds to the second length of the second measuring path so that in the absence of any or almost any flow velocity, the expected value of the comparison parameter for the second measuring path essentially corresponds to the value of the comparison parameter for the first measuring path.

9. The method according to claim 1, wherein at least one further comparison parameter is the frequency spectrum of the measuring signal received by an ultrasonic transducer and/or the signal-to-noise ratio of the measuring signal received by an ultrasonic transducer is used, and wherein, as part of the plausibility check, the value of the at least one further comparison parameter determined on the second measuring signal is compared with the value determined on the first measuring signal, which corresponds to the expected value.

10. An ultrasonic flowmeter comprising:
at least one first ultrasonic transducer pair arranged on a measuring tube such that a first measuring path of a first length is spanned between the ultrasonic transducers of the first ultrasonic transducer pair; and
at least one second ultrasonic transducer pair arranged on the measuring tube arranged such that a second measuring path of s second length is spanned between the ultrasonic transducers of the second ultrasonic transducer pair; and
a control and evaluation unit to control the ultrasonic transducers and to evaluate the measuring signals captured by the ultrasonic transducers,
. wherein the control and evaluation unit performs the method according to claim 1 during an operation thereof.

11. The ultrasonic flowmeter according to claim 10, wherein the first ultrasonic transducer pair comprises a first ultrasonic transducer and a second ultrasonic transducer, and wherein the second ultrasonic transducer pair comprises a third ultrasonic transducer and a fourth ultrasonic transducer, and wherein the first and second ultrasonic transducers are designed as ultrasonic transmitters and as ultrasonic receivers.

12. The ultrasonic flowmeter according to claim 10, wherein the first length of the first measuring path corresponds to the second length of the second measuring path.

13. The ultrasonic flowmeter according to claim 10, wherein the first length of the first measuring path is greater or less than the second length of the second measuring path by a known value.

14. The ultrasonic flowmeter according to claim 10, wherein the first ultrasonic transducer pair and the second ultrasonic transducer pair are arranged in the same flow section.

15. The ultrasonic flowmeter according to claim 10, wherein at least three ultrasonic transducer pairs are provided, which are subjected to a plausibility check during operation to ensure correct functioning.
